(19) United States
(12) Patent Application Publication
(10) Pub. No.: US 2009/0205961 A1
(43) Pub. Date: Aug. 20, 2009

(54) SEPARATION DEVICE COMPRISING A SURFACTANT RELEASING MEANS

(75) Inventors: Dirk Jan Broer, Geldrop (NL); Emiel Peeters, Eindhoven (NL); Ralph Kurt, Eindhoven (NL); Roel Penterman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/302,926

(22) PCT Filed: May 22, 2007
(86) PCT No.: PCT/IB2007/051926

§ 371 Date: Dec. 1, 2008

(30) Foreign Application Priority Data
Jun. 2, 2006 (EP) 06114899.5

(51) Int. Cl. G01N 27/447; C25B 9/00; C25B 15/00

(52) U.S. Cl. 204/456; 204/606

(57) ABSTRACT

To improve automation, especially in 2D gel electrophoresis of proteins, DNA etc., a separation device (1) has a physically activatable means for releasing surfactant, eg. SDS, into the gel fr SDS-PAGE. In one embodiment, surfactant-bound polymer is photolytically cleaved; in another, a barrier layer (30) is melted/destroyed to allow surfactant from reservoir (20) to reach the separation area (10). The barrier layer may comprise a novolac.

The present invention is directed to the field of devices for separation, especially gel electrophoresis of biomolecules.

In the separation of biomolecules, especially of samples which may contain a multitude of biomolecules, techniques which are known as “2D”-separation are widely used. E.g. in the analysis of proteins, first a separation by isoelectric focusing (=a separation by the isoelectric point) and a separation by electrophoresis via the molecular weight is performed, yielding a high resolution in performance. In the second step usually a surfactant (which also denaturizes the proteins) is added, which is in most applications SDS, sodium dodecyl sulfate.

However, in standard gel electrophoresis, the two separation steps are usually performed manually. Furthermore the separation conditions must be changed from the first separation (the first “dimension”) to the second, which is usually done by simply changing the solution the separation material is swollen in. It is not possible to dry the separation material and then add the second separation solution, since the separation material is usually a gel-like polymer made out of acrylic and bisacrylic monomers (for proteins) or agarose (for nucleic acids).

It is therefore an object of the present invention to provide a device, especially for 2D separation of biomolecules which allows a higher degree of automatization.

This object is solved by a separation medium according to claim 1 of the present invention. Accordingly, a device for use in separation, especially 2D separation including a gel electrophoresis step is provided, whereby the device comprises a surfactant releasing means.

The term “surfactant” within the present invention especially means and/or includes a substance which is capable of performing at least one of the following processes
charging or de-charging the biomolecules present in the sample to be analyzed
denaturizing the biomolecules present in the sample to be analyzed
breaking the disulfide bonds in proteins to enhance the formation of random coils.

The term “surfactant releasing means” is in the sense of the present invention to be understood in the broadest way possible. It should be noted that the surfactant releasing means does not necessarily be a somewhat “mechanical means” but may also include a certain kind of chemical compound which is able to release the surfactant when needed.

By using such a device, for most applications at least one of the following advantages can be achieved:
The separation can be automatized to a far larger degree since manually performed steps in between the two separation procedures can be avoided or at least largely reduced
The device can better be implemented in automated analysis devices which e.g. can be applied on a chip for high-screening and high-throughput analysis
A contact of the user with the liquids and /or the surfactants inside the device can in most applications be avoided which avoids contamination of both the user and the analysis system
The device can be composed at different location from the place where it is applied, i.e. it can be manufactured, packaged, transported and directly applied by the end user.

According to a preferred embodiment of the present invention, the surfactant releasing means is capable of releasing ≧0.0005 μmol and ≦5000 μmol of surfactant per mm² of separation area. It has been shown in practice that in most applications this amount is suitable for changing the separation conditions such that the second separation step can be conducted with high accuracy.

According to a preferred embodiment of the present invention, the surfactant releasing means is capable of releasing ≧0.001 μmol and ≦1000 μmol, according to a preferred embodiment of the present invention, the surfactant releasing means is capable of releasing ≧0.002 μmol and ≦200 μmol.

According to a preferred embodiment of the present invention, the surfactant releasing means is capable of releasing ≧0.001 μmol/s and ≦1000 μmol/s of surfactant per mm² of separation area. In most application within the present invention, this greatly helps to reduce the time needed for the separation procedure, thus furthermore increasing the automation potential of the device.

According to a preferred embodiment of the present invention, the surfactant releasing means is capable of releasing ≧0.01 μmol/s and ≦20 μmol/s of surfactant per mm² of separation area, according to a preferred embodiment of the present invention, the surfactant releasing means is capable of releasing ≧0.02 μmol/s and ≦4 μmol/s of surfactant per mm² of separation area.

According to a preferred embodiment of the present invention, the surfactant releasing means is photoactivatable.

The term “photoactivatable” means and/or includes one or more of the following:
Either the surfactant may be present within the separation medium (or in a layer in close vicinity to it) in a “precursor-like” from which it can be released by photochemical or photophysical processes. According to a preferred embodiment of the present invention, the distance of the layer to the separation medium is ≦3 mm, preferably ≦1 mm
According to a further embodiment (which will be more explained later on) also a barrier layer may be influenced by photochemical or photophysical processes thus allowing the surfactant to reach the separation area. According to a preferred embodiment of the present invention, the distance of the layer to the separation medium is ≦3 mm, preferably ≦1 mm.

According to a preferred embodiment of the present invention, the surfactant releasing means is photoactivatable by light with a wavelength of ≧250 nm and ≦450 nm. This wavelength frame is for most application the most suitable for the present invention since it allows a speedy and accurate release of the surfactant and does not or only marginally affect the biological molecules present in the sample and the devices are not too sensitive towards ambient light.

Generic group definition: Throughout the description and claims generic groups have been used, for example alkyl, alkoxy, aryl. Unless otherwise specified the following are preferred groups that may be applied to generic groups found within compounds disclosed herein:

alkyl: linear and branched C1-C8-alkyl,

long-chain alkyl: linear and branched C5-C20 alkyl,

alkylene: selected from the group consisting of:

methylene; 1,1-ethylene; 1,2-ethylene; 1,1-propylidene; 1,2-propylene; 1,3-propylene; 2,2-propylidene; butan-2-ol-1,4-diyl; propan-2-ol-1,3-diyl; 1,4-butylene; cyclohexane-1,1-diyl; cyclohexan-1,2-diyl; cyclohexan-1,3-diyl; cyclohexan-1,4-diyl; cyclopentane-1,1-diyl; cyclopentan-1,2-diyl; and cyclopentan-1,3-diyl,

arylene: selected from the group consisting of: 1,2-phenylene; 1,3-phenylene; 1,4-phenylene; 1,2-naphtalenylene; 1,3-naphtalenylene; 1,4-naphtalenylene; 2,3-naphtalenylene; 1-hydroxy-2,3-phenylene; 1-hydroxy-2,4-phenylene; 1-hydroxy-2,5-phenylene; and 1-hydroxy-2,6-phenylene,

heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl,

heteroarylene: selected from the group consisting of: pyridindiyl; quinolindiyl; pyrazodiyl; pyrazoldiyl; triazolediyl; pyrazindiyl; and imidazolediyl, wherein the heteroarylene acts as a bridge in the compound via any atom in the ring of the selected heteroarylene, more specifically preferred are: pyridin-2,3-diyl; pyridin-2,4-diyl; pyridin-2,5-diyl; pyridin-2,6-diyl; pyridin-3,4-diyl; pyridin-3,5-diyl; quinolin-2,3-diyl; quinolin-2,4-diyl; quinolin-2,8-diyl; isoquinolin-1,3-diyl; isoquinolin-1,4-diyl; pyrazol-1,3-diyl; pyrazol-3,5-diyl; triazole-3,5-diyl; triazole-1,3-diyl; pyrazin-2,5-diyl; and imidazole-2,4-diyl, a —C1-C6-heterocycloalkyl, wherein the heterocycloalkyl of the —C1-C6-heterocycloalkyl is, selected from the group consisting of: piperidinyl; piperidine; 1,4-piperazine, tetrahydrothiophene; tetrahydrofuran; 1,4,7-triazacyclononane; 1,4,8,11-tetraazacyclotetradecane; 1,4,7,10,13-pentaazacyclopentadecane; 1,4-diaza-7-thia-cyclononane; 1,4-diaza-7-oxa-cyclononane; 1,4,7,10-tetraazacyclododecane; 1,4-dioxane; 1,4,7-trithia-cyclononane; pyrrolidine; and tetrahydropyran, wherein the heterocycloalkyl may be connected to the —C1-C6-alkyl via any atom in the ring of the selected heterocycloalkyl,

heterocycloalkylene: selected from the group consisting of: piperidin-1,2-ylene; piperidin-2,6-ylene; piperidin-4,4-ylidene; 1,4-piperazin-1,4-ylene; 1,4-piperazin-2,3-ylene; 1,4-piperazin-2,5-ylene; 1,4-piperazin-2,6-ylene; 1,4-piperazin-1,2-ylene; 1,4-piperazin-1,3-ylene; 1,4-piperazin-1,4-ylene; tetrahydrothiophen-2,5-ylene; tetrahydrothiophen-3,4-ylene; tetrahydrothiophen-2,3-ylene; tetrahydrofuran-2,5-ylene; tetrahydrofuran-3,4-ylene; tetrahydrofuran-2,3-ylene; pyrrolidin-2,5-ylene; pyrrolidin-3,4-ylene; pyrrolidin-2,3-ylene; pyrrolidin-1,2-ylene; pyrrolidin-1,3-ylene; pyrrolidin-2,2-ylidene; 1,4,7-triazacyclonon-1,4-ylene; 1,4,7-triazacyclonon-2,3-ylene; 1,4,7-triazacyclonon-2,9-ylene; 1,4,7-triazacyclonon-3,8-ylene; 1,4,7-triazacyclonon-2,2-ylidene; 1,4,8,11-tetraazacyclotetradec-1,4-ylene; 1,4,8,11-tetraazacyclotetradec-1,8-ylene; 1,4,8,11-tetraazacyclotetradec-2,3-ylene; 1,4,8,11-tetraazacyclotetradec-2,5-ylene; 1,4,8,11-tetraazacyclotetradec-1,2-ylene; 1,4,8,11-tetraazacyclotetradec-2,2-ylidene; 1,4,7,10-tetraazacyclododec-1,4-ylene; 1,4,7,10-tetraazacyclododec-1,7-ylene; 1,4,7,10-tetraazacyclododec-1,2-ylene; 1,4,7,10-tetraazacyclododec-2,3-ylene; 1,4,7,10-tetraazacyclododec-2,2-ylidene; 1,4,7,10,13 pentaazacyclopentadec-1,4-ylene; 1,4,7,10,13-pentaazacyclopentadec-1,7-ylene; 1,4,7,10,13-pentaazacyclopentadec-2,3-ylene; 1,4,7,10,13-pentaazacyclopentadec-1,2-ylene; 1,4,7,10,13-pentaazacyclopentadec-2,2-ylidene; 1,4-diaza-7-thia-cyclonon-1,4-ylene; 1,4-diaza-7-thia-cyclonon-1,2-ylene; 1,4-diaza-7thia-cyclonon-2,3-ylene; 1,4-diaza-7-thia-cyclonon-6,8-ylene; 1,4-diaza-7-thia-cyclonon-2,2-ylidene; 1,4-diaza-7-oxacyclonon-1,4-ylene; 1,4-diaza-7-oxa-cyclonon-1,2-ylene; 1,4diaza-7-oxa-cyclonon-2,3-ylene; 1,4-diaza-7-oxa-cyclonon-6,8-ylene; 1,4-diaza-7-oxa-cyclonon-2,2-ylidene; 1,4-dioxan-2,3-ylene; 1,4-dioxan-2,6-ylene; 1,4-dioxan-2,2-ylidene; tetrahydropyran-2,3-ylene; tetrahydropyran-2,6-ylene; tetrahydropyran-2,5-ylene; tetrahydropyran-2,2-ylidene; 1,4,7-trithia-cyclonon-2,3-ylene; 1,4,7-trithia-cyclonon-2,9-ylene; and 1,4,7-trithia-cyclonon-2,2-ylidene,

heterocycloalkyl: selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thiacyclononanyl; 1,4-diaza-7-oxa-cyclononanyl; 1,4,7,10-tetraazacyclododecanyl; 1,4-dioxanyl; 1,4,7-trithiacyclononanyl; tetrahydropyranyl; and oxazolidinyl, wherein the heterocycloalkyl may be connected to the compound via any atom in the ring of the selected heterocycloalkyl,

halogenalkyl: selected from the group consisting of mono, di, tri-, poly and perhalogenated linear and branched C1-C8-alkyl.

Unless otherwise specified the following are more preferred group restrictions that may be applied to groups found within compounds disclosed herein:

alkyl: linear and branched C1-C6-alkyl,

long-chain alkyl: linear and branched C5-C10 alkyl, preferably linear C6-C8 alkyl,

aryl: selected from group consisting of: phenyl; biphenyl; naphthalenyl; anthracenyl; and phenanthrenyl,

According to a preferred embodiment of the present invention, the device comprises a layer close to the separation area which comprises a material of the structure I

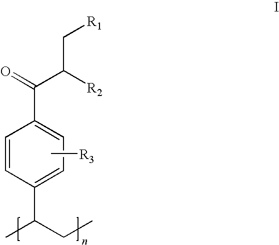

with n being an integer (n may also be 1), R1 selected from the group comprising long-chain alkyl sulfates, long-chain alkenyl sulfates, long-chain alkyl substituted with quarternary ammonium salts, long-chain alkyl carboxylates, long-chain alkyl benzosulfates, long-chain alkyl perchlorates, long-chain alkyl phenols, long-chain alkyl phosphates, long-chain alkyl thiols, long-chain alkyl dithiol, long-chain alkyl dithiothreitol, long-chain alkyl dithioerythritol, and mixtures thereof, R2 selected from the group comprising alkyl, alkylen, halogenalkyl, aryl and R3 selected from the group comprising hydrogen, halogen, nitro, sulfonate, alkyl, aryl.

It has been shown in practice that such a material may be photoactivated to release the surfactant material, probably via a radical mechanism. However, usually a mixture of two products is found, but in most applications these two products are suitable surfactants within the present invention.

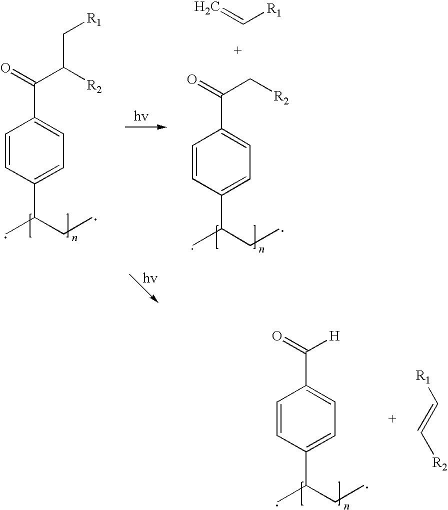

According to a preferred embodiment of the present invention, the device comprises a layer close to the separation area which comprises a material which includes the following structure II

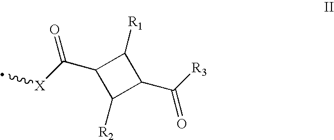

with X being C, NH, O or S, R1 selected from the group comprising aryl, heteroaryl, heteroarylene, heterocycloalkylene, R2 selected from the group comprising aryl, heteroaryl, heteroarylene, heterocycloalkylene and R3 selected from the group comprising long-chain alkyl sulfates, long-chain alkenyl sulfates, long-chain alkyl substituted with quarternary ammonium salts, long-chain alkyl carboxylates, long-chain alkyl benzosulfates , long-chain alkyl perchlorates, long-chain alkyl phenols, long-chain alkyl phosphates, long-chain alkyl thiols, long-chain alkyl dithiol, long-chain alkyl dithiothreitol, long-chain alkyl dithioerythritol.

The bond

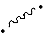

in structure II is supposed to indicate that the structure may be linked e.g. to a polymeric backbone either directly or via spacer groups such as alkyl, ether, polyether etc.

It has been shown in practice that the structure II may form a photochemically-driven equilibrium with two olefinic species, probably as follows:

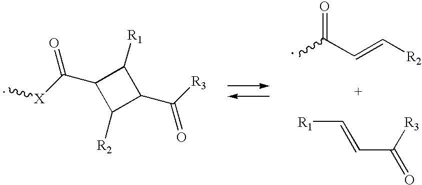

In most applications, it is possible to shift the equilibrium towards the right by irradiation at 254 nm, whereas by exposure with 365 the equilibrium is shifted towards the left.

According to another preferred embodiment, the surfactant releasing means comprises a film of a material which comprises the structure II as a latent surfactant layer with the separation area. Upon exposure with 254 nm light the surfactant is released. According to a preferred embodiment of the present invention, the distance of the layer to the separation medium is ≦3 mm, preferably ≦1 mm.

However, since the reaction can be reversed by exposure with 365 nm light, it is possible to bind the released surfactant back to the surfactant layer. An additional advantage of this embodiment is that during the second exposure the bonded denaturated proteins or DNA fragments may also be immobilized at the surface thus creating a stable pattern of separated species. According to a preferred embodiment of the present invention, the distance of the layer to the separation medium is ≦3 mm, preferably ≦1 mm.

According to a preferred embodiment of the present invention, the surfactant releasing means is a barrier layer, which degrades upon photoactivation. According to a preferred embodiment of the present invention, the distance of the layer to the separation medium is ≦3 mm, preferably ≦1 mm.

According to a preferred embodiment of the present invention, the surfactant releasing means is thermoactivatable.

The term “thermoactivatable” means and/or includes one or more of the following:
Either the surfactant may be present within the separation medium (or in a layer in close vicinity to it) in a “precursor-like” from which it can be released by thermochemical or thermophysical processes. According to a preferred embodiment of the present invention, the distance of the layer to the separation medium is ≦3 mm, preferably ≦1 mm.
According to a further embodiment (which will be more explained later on) also a barrier layer may be influenced by thermochemical or thermophysical processes thus allowing the surfactant to reach the separation area. According to a preferred embodiment of the present invention, the distance of the layer to the separation medium is ≦3 mm, preferably ≦1 mm.

According to a preferred embodiment of the present invention, the surfactant releasing means is thermoactivatable by heating to a temperature of ≧25° C. and ≦85° C. This has been shown in most applications to be the best suitable temperature range since by doing so the surfactant can be effectively be released without harming the biomolecules present in the sample.

According to a preferred embodiment of the present invention, the surfactant releasing means is thermoactivatable by heating to a temperature of ≧35° C. and ≦75° C., according to a preferred embodiment of the present invention, the surfactant releasing means is thermoactivatable by heating to a temperature of ≧45° C. and ≦65° C.

According to a preferred embodiment of the present invention, the thermoactivatable surfactant releasing means comprises a barrier layer as will be described later on.

According to a preferred embodiment of the present invention, the surfactant releasing means is mechanically activatable.

According to a preferred embodiment of the present invention, the surfactant releasing means comprises hollow polymeric spheres in which the surfactant to be released is provided.

It has been shown in a wide range of applications within the present invention that by doing so the surfactant can be released by applying force, i.e. by the fingers or the thumb of the user.

According to a preferred embodiment of the present invention, the hollow polymeric spheres have an average size between ≧0.1 and ≦20 μm, and a more preferred size between ≧1 and ≦10 μm.

According to a preferred embodiment of the present invention, the hollow polymeric spheres comprise a polylactid material.

According to a preferred embodiment of the present invention, the hollow polymeric spheres are manufactured by a double emulsion process.

The term “double emulsion process” in the sense of the present invention means and/or includes especially that an aqueous solution of the surfactant material to be encapsulated by the spheres is emulsified in an ultrasonic bath of an organic solution, preferably comprising toluene and/or tetrahydrofuran, more preferred 70% toluene and 30% tetrahydrofuran with poly(butyl methacrylate-block-methacrylic acid (preferably 70/30). After that this primary water-in-oil emulsion is dispersed in water again with formation of a double water-oil-water emulsion; after this the organic solvent mixture is removed with formation of hollow polymeric spheres filled with the surfactant material.

According to a preferred embodiment of the present invention, the surfactant releasing means comprises a power applying means, preferably in form of a piezo element and/or an ultrasound means which applies power by ultrasound.

According to a preferred embodiment of the present invention, the surfactant which is released by the surfactant releasing means comprises a structure selected from the group comprising long-chain alkyl sulfates, long-chain alkenyl sulfates, long-chain alkyl substituted with quarternary ammonium salts, long-chain alkyl carboxylates, long-chain alkyl benzosulfates , long-chain alkyl perchlorates, long-chain alkyl phenols, long-chain alkyl phosphates, long-chain alkyl thiols, long-chain alkyl dithiol, long-chain alkyl dithiothreitol, long-chain alkyl dithioerythritol, and mixtures thereof, whereby the surfactant may be further substituted.

According to a preferred embodiment of the present invention, the device comprises a separation area, at least one barrier layer in vicinity to the separation area and at least one surfactant reservoir, whereby the surfactant releasing means destroys and/or influences at least the barrier layer upon activation so that surfactant can reach the separation area from the surfactant reservoir. According to a preferred embodiment of the present invention, the distance of the layer to the separation medium is ≦3 mm, preferably ≦1 mm.

In the sense of the present invention, the term “separation area” means and/or includes especially the area, which will in most applications be a somewhat layer-like substrate material, where the separation of the sample to be analyzed takes place.

According to an embodiment of the present invention, the surfactant releasing means is the at least one barrier layer. According to a preferred embodiment of the present invention, the distance of the layer to the separation medium is ≦3 mm, preferably ≦1 mm.

According to an embodiment of the present invention, the surfactant releasing means is a barrier layer which melts upon heating, preferably upon heating above a temperature of ≧35° C., preferably ≧45° C., and most preferred ≧55° C.

According to an embodiment of the present invention, the surfactant releasing means is a barrier comprising a material selected out of the group comprising paraffin, polycaprolactone, ethylene vinylacetate copolymers or mixtures thereof.

According to an embodiment of the present invention, the surfactant releasing means is a barrier layer, which degrades upon photoactivation. According to a preferred embodiment of the present invention, the distance of the layer to the separation medium is ≦3 mm, preferably ≦1 mm.

According to an embodiment of the present invention, the surfactant releasing means is a barrier layer which changes its solubility and permeability upon photoactivation. According to a preferred embodiment of the present invention, the distance of the layer to the separation medium is ≦3 mm, preferably ≦1 mm.

According to an embodiment of the present invention, the surfactant releasing means is a barrier layer, which degrades upon photoactivation by exposing to light with a wavelength of ≧250 nm and ≦450 nm, preferably ≧270 nm and ≦300 nm.

According to an embodiment of the present invention, the surfactant releasing means is a barrier layer which includes a cyclic α-diazo ketone moiety. These compounds are in most applications within the present invention able to perform a rearrangement to a carboxylic acid derivative, e.g. according to the following mechanism:

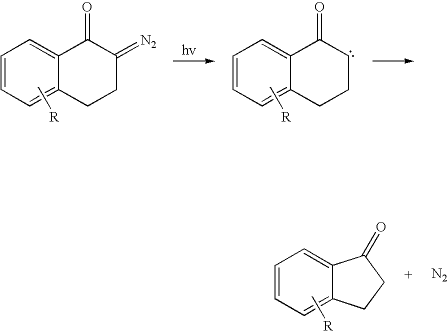

The ketene compound is then reacting with nucleophiles such as amines, alcohols or water to a carboxylic acid. It should be noted that the above mechanism is for illustrative purposes only.

According to an embodiment of the present invention, the surfactant releasing means is a barrier layer which includes a cyclic α-diazo ketone moiety of the structure III

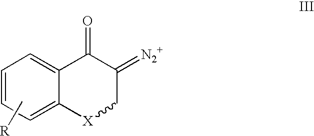

whereby R is selected out of the group comprising alkyl, alkoxy, halogen, aryl, heteroaryl and X is independently selected out of the group comprising C, N, O and S.

It should be noted that the way of indication and/or notation for R does not mean or intend that there is only one substituted residue in each of the aromatic rings; rather the formula is to be read as if all possible substitutions (from mono-di- to quinquies substitution) were meant by this notation. This also goes for all further structures mentioned in this application.

The term “includes” means and/or includes that the following structure may either be present as a moiety within a polymeric backbone or that a molecule with this structure may be present in the layer as a separate component.

Furthermore it should be noted that the above structure is according to an embodiment of the present invention linked (via a suitable R moiety) to a polymeric backbone.

The bond

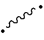

is supposed to indicate that either a single or a double bond may be present.

According to a further embodiment of the present invention, the surfactant releasing means is a barrier layer comprising a Novolac and/or polyvinylphenol material which may be added as blend to or be co-polymerized with a component of structure III

In the sense of the present invention, the term “Novolac” means and/or includes especially the reaction product of phenol or cresol with formaldehyde with the following general structure

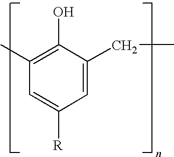

The present invention furthermore relates to method for separating a sample using a device according to the present invention, comprising the steps of:
a) conducting a first separation step
b) activating the surfactant releasing means to release a surfactant in a suitable amount
c) conducting a second separation step

It should be noted that in the sense of the present invention, the term “separation” is to be understood in its broadest sense and means and/or includes especially one or more of the following:
A process used for separating mixtures by virtue of differences in absorbency
A process in which a chemical mixture carried by a liquid or gas is separated into components as a result of differential distribution of the solutes as they flow around or over a stationary liquid or solid phase
any of a diverse group of techniques used to separate mixtures of substances based on differences in the relative affinities of the substances for two different media, one (the mobile phase) a moving fluid and the other (the stationary phase or sorbent) a porous solid and/or gel and/or a liquid coated on a solid support
separation techniques which result of different charges and/or masses under the influence of an external force, especially an external field and/or pH, such as e.g. isoelectrical focusing.

It should be noted that the device according to the present invention may be of use—but not limited to—for separation of biological molecular compounds such as, but not limited to, nucleic acids and related compounds (e.g. DNAs, RNAs, oligonucleotides or analogs thereof, PCR products, genomic DNA, bacterial artificial chromosomes, plasmids and the like), proteins and related compounds (e.g. polypeptides, peptides, monoclonal or polyclonal antibodies, soluble or bound receptors, transcription factors, and the like), antigens, ligands, haptens, carbohydrates and related compounds (e.g. polysaccharides, oligosaccharides and the like), cellular fragments such as membrane fragments, cellular organelles, intact cells, bacteria, viruses, protozoa, and the like.

A device and/or method according to the present invention may be of use in a broad variety of systems and/or applications, amongst them one or more of the following:
biosensors used for molecular diagnostics
rapid and sensitive detection of proteins and nucleic acids in complex biological mixtures such as e.g. blood or saliva
high throughput screening devices for chemistry, pharmaceuticals or molecular biology
testing devices e.g. for DNA or proteins e.g. in criminology, for on-site testing (in a hospital), for diagnostics in centralized laboratories or in scientific research
tools for DNA or protein diagnostics for cardiology, infectious disease and oncology, food, and environmental diagnostics
tools for combinatorial chemistry
analysis devices.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several preferred embodiments of a separation medium as well as a device according to the invention.

FIG. 1 shows a very schematic top-view of a separation area according to a first embodiment of the present invention prior to the injection of a sample to be separated

FIG. 2 shows a very schematic top view of the separation area of FIG. 1 after performing one separation step

FIG. 3 shows a very schematic top view of the separation area of FIG. 1 and FIG. 2 after performing a further separation step

FIG. 4 shows a very schematic partial cut-out side view of the device after performing the first separation step prior to the release of surfactant material; and

FIG. 5 shows a very schematic cut-out side view of the device after performing the first separation step after the release of surfactant material.

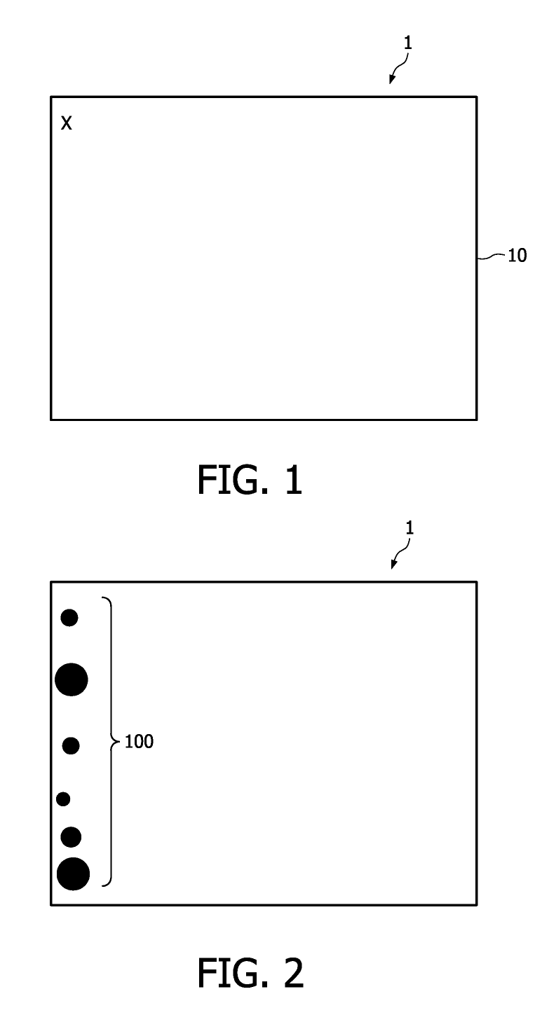

FIG. 1 shows a very schematic top-view of a separation area 10 according to a first embodiment of the present invention 1 prior to the injection of a sample to be separated. The sample is (in this embodiment) injected around the position “x”. FIG. 2 shows the separation area 10 after performing the first separation step, which is e.g. an isoelectric focusing. In case the sample contains proteins (which may furthermore be present as a superstructure of several proteins which form e.g. a multicomponent complex) the proteins will be present after the first separation step more or less in their native, folded state as indicated by the circles 100, e.g. biomolecules.

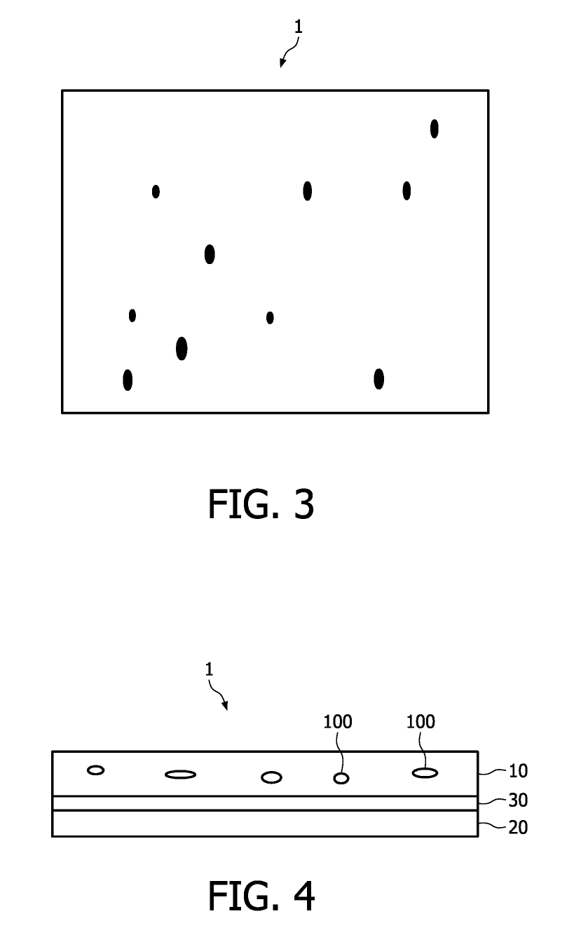

FIG. 3 shows a schematic top view of the separation area of FIG. 1 and FIG. 2 after performing a further separation step. In this second step e.g. an electrophoresis which separates the molecules by its molecular weight has been performed. It can be seen that some of the “circles” of FIG. 2 consist out of several biomolecules, which are now separate spots. A separation of former connected biomolecules 100 into the components has been processed.

FIG. 4 shows a very schematic partial cut-out side view of a device 1 according to a first embodiment of the present invention after performing the first separation step prior to the release of surfactant material. The surfactant material is contained in a layer 30. A barrier layer 20 (which acts as surface releasing means) divides the surfactant releasing layer 30 and the separation area, in which biomolecules 100 are present in their native, folded state.

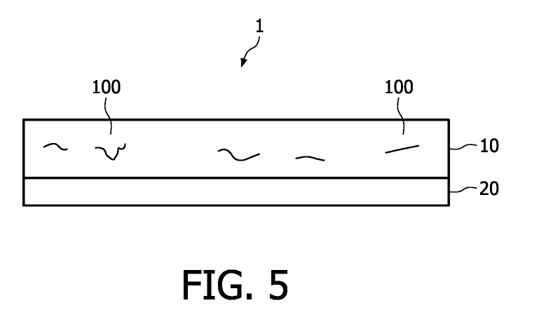

FIG. 5 shows a very schematic cut-out side view of the device 1 after performing the first separation step after the release of surfactant material. The surface releasing means (which was the barrier layer) has been activated. In the present embodiment, the surface releasing means was a barrier layer which melted upon heating, thus allowing the surfactant material to reach the separation area 10 from the layer 30. Upon contact with the surfactant material, the biomolecules 100 become unfolded and are therefore present in their denaturated state. The second separation step (as described in FIG. 3) can now be performed.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The scope of the invention is defined in the following claims and the equivalents thereto. Furthermore, reference signs used in the description and claims do not limit the scope of the invention as claimed.

1. A device for use in separation, especially 2D separation of biomolecules including a gel electrophoresis step, whereby the device comprises a surfactant releasing means.

2. The device according to claim 1, whereby the surfactant releasing means is capable of releasing ≧0.0005 μmol and ≦5000 μmol of surfactant per mm² of separation area.

3. The device according to claim 1, whereby the surfactant releasing means is capable of releasing ≧0.001 μmol/s and ≦1000 μmol/s of surfactant per mm² of separation area.

4. The device according to claim 1, whereby the surfactant releasing means is photoactivatable.

5. The device according to claim 1, whereby the surfactant releasing means is thermoactivatable.

6. The device according to claim 1, whereby the surfactant releasing means is mechanically activatable.

7. The device according to claim 1, whereby the surfactant which is released by the surfactant releasing means comprises a structure selected from the group comprising long-chain alkyl sulfates, long-chain alkenyl sulfates, long-chain alkyl substituted with quarternary ammonium salts, long-chain alkyl carboxylates, long-chain alkyl benzosulfates, long-chain alkyl perchlorates, long-chain alkyl phenols, long-chain alkyl phosphates, long-chain alkyl thiols, long-chain alkyl dithiol, long-chain alkyl dithiothreitol, long-chain alkyl dithioerythritol, and mixtures thereof, whereby the surfactant may be further substituted.

8. A device according to claim 1, whereby the device comprises a separation area, at least one barrier layer in vicinity to the separation area and at least one surfactant reservoir, whereby the surfactant releasing means destroys and/or influences the at least one barrier layer upon activation so that surfactant can reach the separation area from the surfactant reservoir.

9. A method for separating a sample using a device according to claim 1, comprising the steps of:
a) conducting a first separation step
b) activating the surfactant releasing means to release a surfactant in a suitable amount
c) conducting a second separation step

10. A system incorporating a device according to claim 1 and being used in one or more of the following applications:
biosensors used for molecular diagnostics
rapid and sensitive detection of proteins and nucleic acids in complex biological mixtures such as e.g. blood or saliva
high throughput screening devices for chemistry, pharmaceuticals or molecular biology
testing devices e.g. for DNA or proteins e.g. in criminology, for on-site testing (in a hospital), for diagnostics in centralized laboratories or in scientific research
tools for DNA or protein diagnostics for cardiology, infectious disease and oncology, food, and environmental diagnostics
tools for combinatorial chemistry
analysis devices.
